(19) United States
(12) Patent Application Publication
(10) Pub. No.: US 2015/0350811 A1
(43) Pub. Date: Dec. 3, 2015

(54) Bluetooth Broadcasting System and Method

(71) Applicant: ANTONIO FERNANDEZ, Miami, FL (US)

(72) Inventor: ANTONIO FERNANDEZ, Miami, FL (US)

(21) Appl. No.: 14/294,105

(22) Filed: Jun. 2, 2014

(51) Int. Cl. H04W 4/00; H04W 4/22; H04H 60/90

(52) U.S. Cl. CPC H04W 4/008; H04H 60/90; H04W 4/22

(57) ABSTRACT

A Bluetooth broadcasting system uses Bluetooth technology to deliver content between communication devices in a common network. The content is delivered and received publicly, anonymously, or selectively with codes. The content includes emergency broadcasts, nonemergency broadcasts, or personal broadcasts. The type of content dictates how the content is delivered. For example, an emergency broadcast is publicly delivered from a victim to all communication devices having the software application and Bluetooth enabled. While a personal message is delivered from a sender to a recipient who share a unique and private code. A range module enables public safety personnel to set a desired range for emergency messages. A code module displays to recipients to select a correct code for receiving a nonemergency and personal message. An information level module enables a sender to set the amount of personal and contact information to be delivered. The messages can be recorded, saved, and sent.

### BACKGROUND

It is known that Bluetooth is a wireless technology standard for exchanging data over short distances. Typically, Bluetooth protocol utilizes short-wavelength UHF radio waves in the ISM band from 2.4 to 2.485 GHz from fixed and mobile devices, and building personal area networks. Key features that Bluetooth offers include robustness, low complexity, low power, and low cost. The Bluetooth system has been developed and implemented in many devices, such as personal digital assistants (PDAs), notebooks, and cellular phones.

It is known that personal computer and mobile communications use has steadily increased in recent years, motivated in part by the birth of the Internet. The combination of mobile communications and the Internet makes possible a new set of communications tools and can expand the media, services and manufacturing industries that have contributed to the growth of personal communications.

Typically, 3G devices are capable of telephony, Internet access, PC-like applications and video streaming, among others. Many of these devices are enabled with Bluetooth capabilities. Bluetooth is a low power, short range radio technology that may be used to connect one device to another. Bluetooth was developed to standardize wireless communications between devices, removing the need for physical wires to make a connection between devices.

Typical message delivery systems on wireless networks have sustained themselves due to strict adherence to a small file size requirement. The cost of a wireless network delivering larger file size content such as a video clip or an image file on demand would be prohibitively expensive, as well as time-consuming, to the end-user.

It is known that there exist various methods for delivering emergency broadcast messages. Broadcast of emergency messages in televisions includes a bright band with floating text that displays the alert message while the message broadcast through radio includes a characteristic beep followed by the emergency broadcast. In the case of television emergency messages, a current implementation provides a display of text of the emergency message on the screen. Often emergency vehicles can drive around a region and deliver the emergency broadcast with a loud speaker. These techniques, however rely on the intended recipients sitting in front of a television, or being within audible range of the loud speaker at the time the emergency vehicle drives by.

Typically, in public arrangements or on public places there is an increasing possibility of coming into contact with other persons over radio networks. In particular with so-called peer-to-peer networks, often a mutual identification is necessary. A typical scenario is, for example, the setting up of contact with likeminded persons in an airport lounge. Over mobile devices, like for example PDAs or smartphones it is possible to identify such persons over a short-distance radio link, such as an IEEE 802.11 wireless LAN and mutually exchange personal information. However, since there is still no bond of trust between the persons, the sender runs the risk of the other person receiving his data, but on the other hand not revealing her personal data.

Often, a Bluetooth enabled device typically requires the user to set up a paired connection with a remote device before the devices can exchange information. Setting up this connection requires an authentication phase, whereby the user may be required to enter a password or personal identification number (PIN) to register the remote device in each device's table of paired devices. For example, cellular mobile phones may require the user to manually enter a PIN before the phone will pair with a remote headset. As a result, the user must enter a PIN every time it is desired to connect with a new device that is encountered.

Bluetooth provides a solution to the communication and security problems that arise while trying to deliver emergency, nonemergency, and personal content in an effective and selective manner.

Bluetooth technology has been used for communicating wirelessly in the past, yet none with the present characteristics of the present invention. See Patent numbers: U.S. 20090017798; U.S. Pat. No. 7,860,456; and WO2003061224.

For the foregoing reasons, there is a need for a Bluetooth broadcasting system that delivers emergency, nonemergency, and personal content between communication devices in a common network.

### SUMMARY

The present invention is directed to a Bluetooth broadcasting system and method that uses short range wireless connectivity protocols, such as Bluetooth technology, to deliver content between communication devices in a common network. The content can be delivered and received publicly, anonymously, or selectively with permission based codes. The content includes emergency broadcasts, nonemergency broadcasts, or personal broadcasts. The type of content dictates how the content is delivered. For example, an emergency broadcast is publicly delivered from a victim to all communication devices having the software application. While a personal message is delivered from a sender to a recipient who share a unique and private code.

Those skilled in the art will recognize that Bluetooth is a wireless technology that exchanges data over short distances using short-wavelength UHF radio waves in the ISM band from about 2.4 to 2.485 GHz. The data can be exchanged from fixed and mobile devices, and building personal area networks. The Bluetooth technology used by the system is especially effective for emergency broadcasts, since the Bluetooth protocol is designed to operate in noisy radio frequency environments. This is possible because Bluetooth uses a fast acknowledgement and frequency-hopping scheme to make the link robust, communication-wise. The capacity to select a range for the communication by controlling the number of hops is useful for either emergency or private broadcasts. In this manner, the advantages provided by Bluetooth technology can customize broadcasts for different situations.

In some embodiments, the system comprises three types of broadcasts, which may be visible on a display screen of both the master and slave communication devices. The broadcasts are selective from a Broadcast Module having the following broadcasts: 1) an Emergency Broadcast; 2) a Nonemergency Broadcast; and 3) a Personal Broadcast. The master and slave communication devices select the appropriate broadcast and subsequent options that arise from the broadcast, such as a range for the message, a code for regulating reception of the message, and different amounts of personal and contact information levels.

The Emergency Broadcast can be used for emergency situations that require the general public to be alerted with an emergency message. In some embodiments, the slave communication device that transmits the Emergency Broadcast may be a victim of a crime, a natural disaster, or a health crisis. The slave communication device can select from an Emergency Type Module to indicate to others in the network, including public safety personnel, the nature of the emergency and to alert and request help. Selecting from the Emergency Type Module on the slave communication device displays various types of emergencies, such as Medical, Fire, Assault, to the master. The master communication device has the option of selecting the range of reception of the emergency message through a Range Module. Generally, only public safety personnel have access to the Range Module. For example, a public safety personnel need not respond to emergency broadcasts beyond a mile. The Range Module allows for expanded message dispersion by retransmitting by the slave communication device (message recipient) over a limited number of hops. The slave communication device controls the number of hops through a timer that incrementally reduces by a unit of 1 until zero is reached. In some embodiments, an emergency Audio Record Module provides the option to record and/or save and/or send a prerecorded message. This is available to public safety personnel. The Emergency Broadcast does not require a code to receive the broadcast. The Emergency Broadcast transmits to all communication devices in the network that have the software application. An Audio Record Module allows the public safety personnel to prerecord, save, and send a broadcast, such as weather alert, escaped fugitive warnings, and the like.

The Nonemergency Broadcast can be used for broadcasting a nonemergency message that is generally public in nature. In some embodiments, the master or slave communication device that transmits and receives the Nonemergency Broadcast may broadcast an advertising campaign or a company meeting. However, any form of general, nonemergency communications may be initiated through the Nonemergency Broadcast.

The Nonemergency Broadcast utilizes a nonemergency code to enable reception of the nonemergency message to authorized recipients. Additionally, the amount of information delivered in the nonemergency message can be customized.

The Nonemergency Broadcast provides a Broadcast Type Module to give the option of broadcasting a Calling Card Broadcast, a Customized Broadcast, and a Voice Broadcast. The Calling Card Broadcast includes general contact information from a sender. The contact information may be prewritten, and simply broadcast as a data packet. The Custom Broadcast initiates a Dictation Module that enables the sender to dictate a message to the intended recipient. The Voice Broadcast enables the sender to record, save, and send a message through a Nonemergency Audio Record Module. In any of the aforementioned broadcasts, the slave communication device (recipient) must select the correct code to receive the message while communicating in the Nonemergency Broadcast. The codes appear on a Nonemergency Code Module for all communication devices in the network. However, only the recipients that know the code can engage the Nonemergency Code Module.

The Personal Broadcast can be used to deliver a personal message, such as personal one-on-one communications, often intended to be private. Selecting the Personal Broadcast delivers a code enabled personal message to a recipient. The personal message can be tailored to contain various amounts of detail through an Information Level Module. The Information Level Module enables customization of the amount of personal and contact information relayed to the intended recipient. For example, a picture, name, and phone; or a picture, name, phone, and email; or a prewritten business card.

In some embodiments, Personal Broadcast requires the intended recipient to have a personal code prior to receiving the message. The sender can inform the recipient of the personal code either verbally, or through various signals. The signals correlate to a code and appear on the slave communication device. The Personal Code Module shows the symbols for the code, and also provides the option of rejecting the Personal Broadcast. In this manner, the sender can perform the signal from a distance so that the intended recipient knows which code to use. In another embodiment, the master communication device displays a plurality of potential recipients for the personal message. The master communication device can then select the desired recipient to send the message to. The sender may then relay the code through the described techniques. The recipient can also reject a message by ignoring requests in a predetermined duration. The slave communication device must input the same code as the master communication device to receive the personal message. There may be a time limitation on entering the code as an additional security feature.

One objective of the present invention is to provide a short-range broadcast system that delivers messages through a Bluetooth protocol.

In yet another objective, a selective, quick targeted communication to a specific recipient or group of recipients within a predetermined range is possible.

In yet another objective, the system provides the option of delivering the broadcast publicly, anonymously, or selectively with permission based codes.

In yet another objective, a master and slave communication device share the same system software application to form a common network of communication. The master and slave are reversible, and multiple slaves can receive and/or send broadcasts. The system software application is downloadable.

In yet another objective, the various broadcasts and subsequent options thereto display as Modules through a Graphical user interface on the master and slave communication devices.

In yet another objective, an Emergency Broadcast delivers emergency content, often prerecorded, to a network of recipients in a predetermined range.

In yet another objective, a public safety personnel decides the range for delivering the broadcast.

In yet another objective, a public safety personnel can prerecord, save, and send a broadcast for future delivery.

In yet another objective, a victim can broadcast a specific emergency to all communication devices in the network within a predetermined range.

In yet another objective, a code is required for receiving a message in the Nonemergency Broadcast and the Personal Broadcast. The code can be relayed to the intended recipient through various techniques. The recipient can ignore the broadcast from a sender by not providing the code within a predetermined duration.

In yet another objective, different mediums for delivery of the broadcasts can be selected, such as a Calling Card Broadcast, a Custom Broadcast, and a Voice Broadcast.

In yet another objective, different levels of information can be selected, such as a picture, name, and phone; or a picture, name, phone, and email; or a prewritten business card. The information can be customized through an Information Level Module, a Dictation Module, and an Audio Record Module.

In yet another objective, from the Person Broadcast, a sender can relay hand signals to a recipient that correlate to personal codes on the recipient's communication device. The recipient may then select the correlating code for the signal.

In yet another objective, from the Person Broadcast, the sender can visually identify the potential recipients in a predetermined range, and selectively broadcast the message accordingly. In any case, the recipient must still know the personal code to receive the message.

### DRAWINGS

These and other features, aspects, and advantages of the present invention will become better understood with regard to the following description, appended claims, and drawings where:

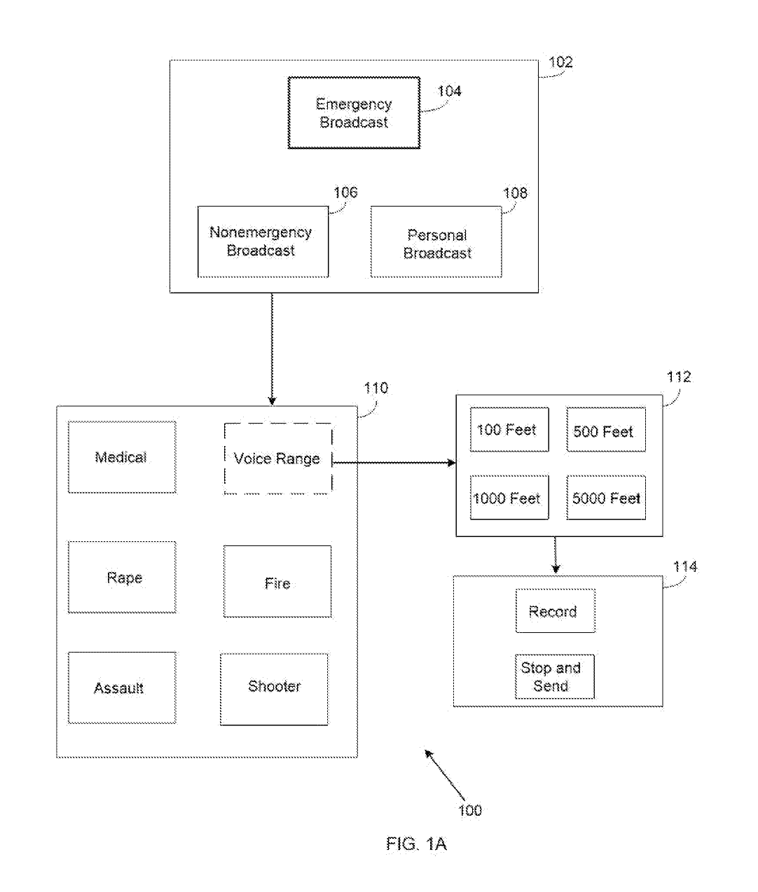

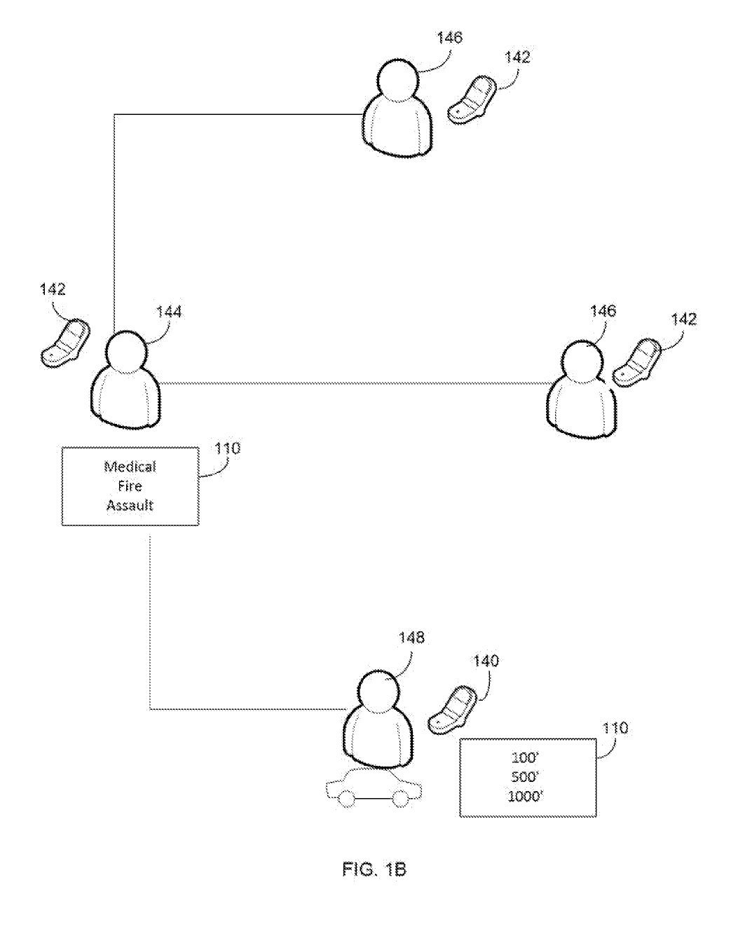

a. FIGS. 1A and 1B is an exemplary emergency broadcast for a Bluetooth broadcasting system, where FIG. 1A is an exemplary communication device display, and FIG. 1B is an exemplary communication between a sender, a recipient, and public safety personnel;

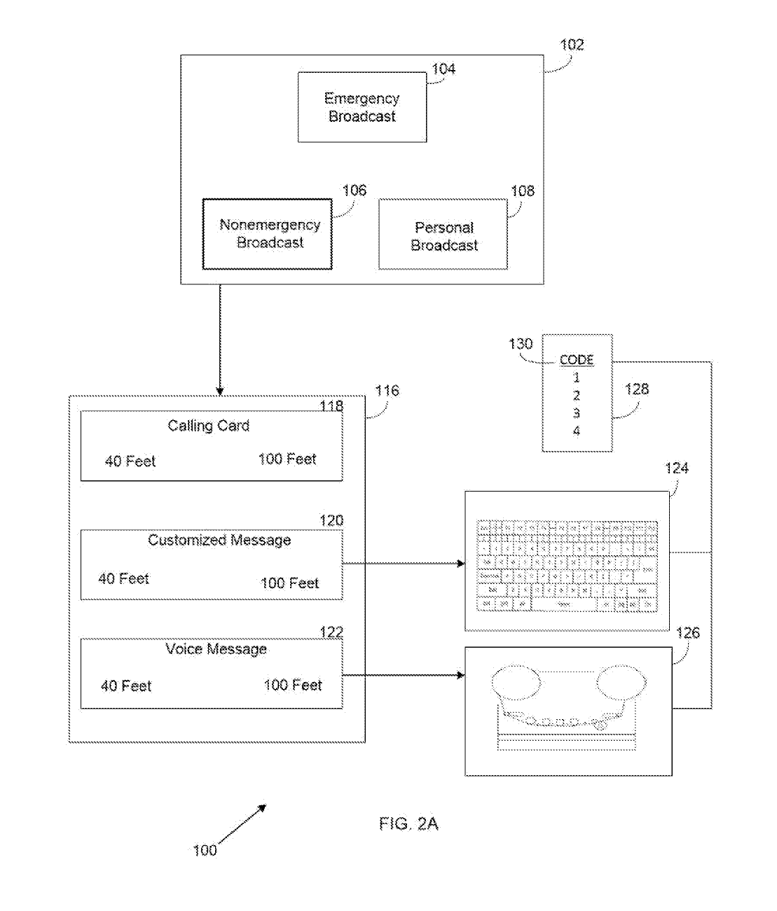

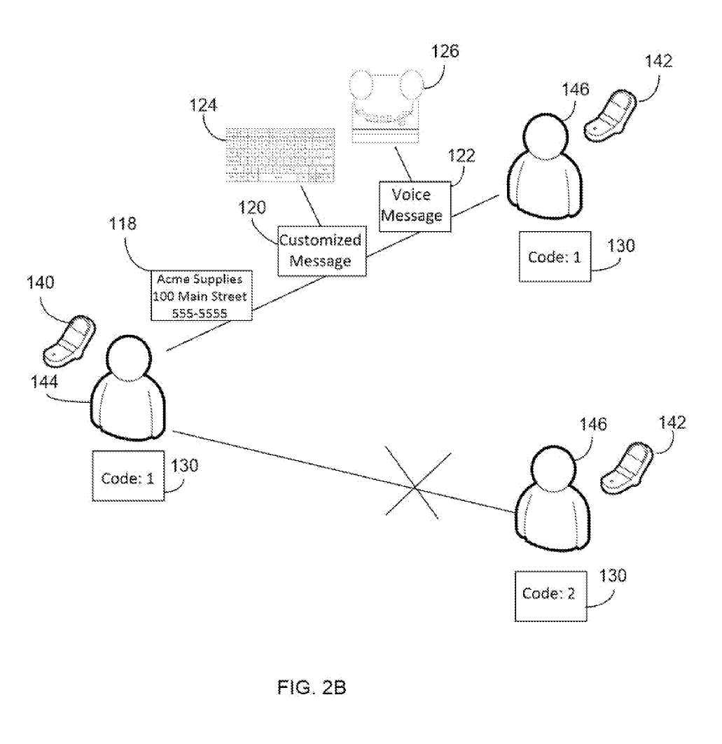

b. FIGS. 2A and 2B is an exemplary nonemergency broadcast for a Bluetooth broadcasting system, where FIG. 2A is an exemplary communication device display, and FIG. 2B is an exemplary communication between a sender and a recipient;

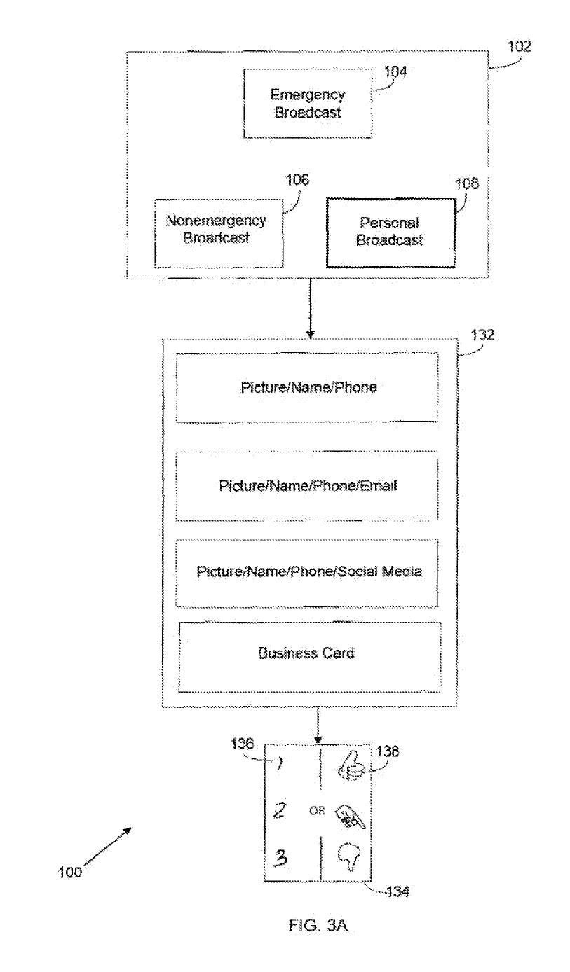

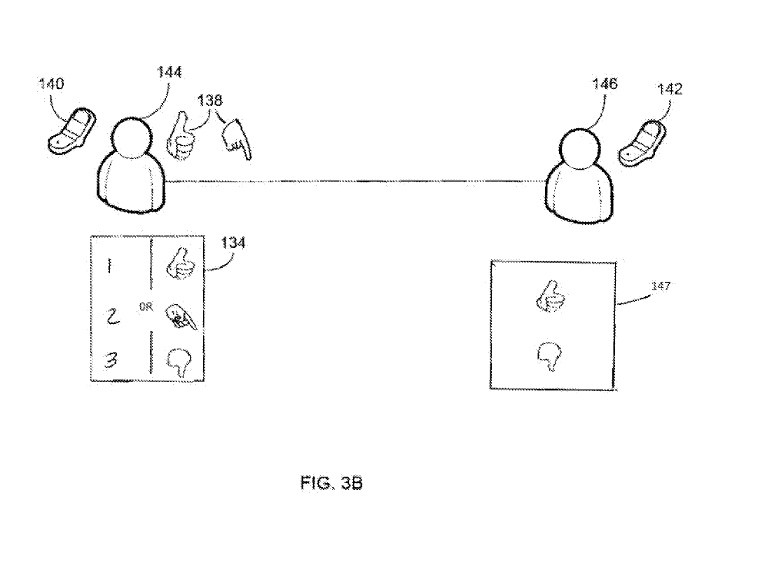

c. FIGS. 3A and 3B is an exemplary personal broadcast for a Bluetooth broadcasting system, where FIG. 3A is an exemplary communication device display, and FIG. 3B is an exemplary communication between a sender and a recipient;

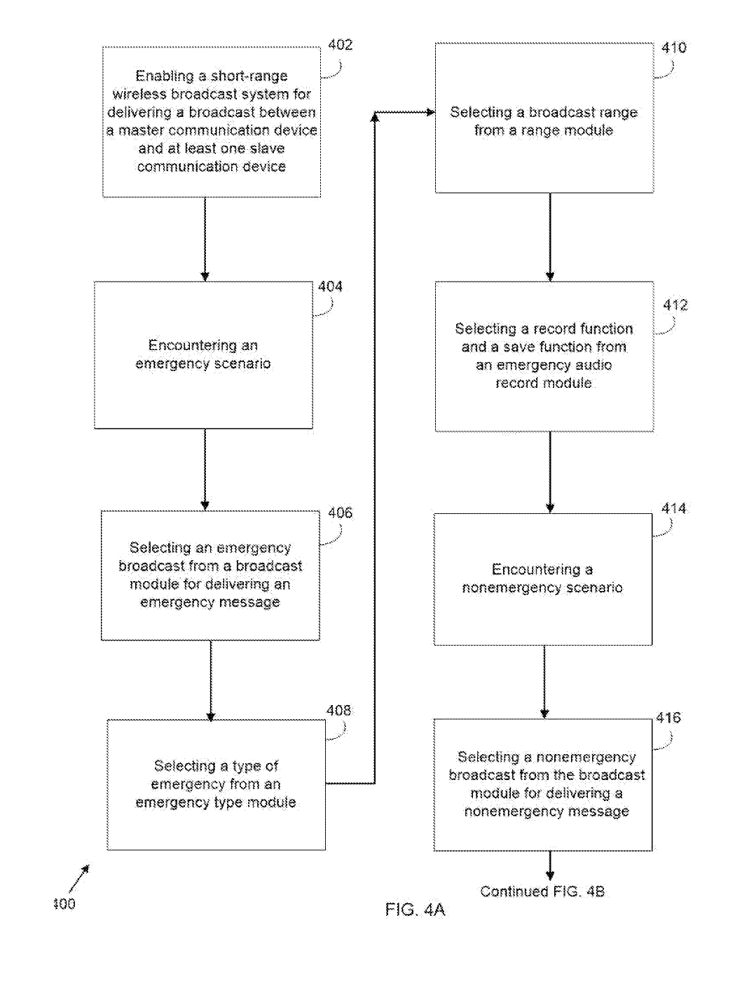

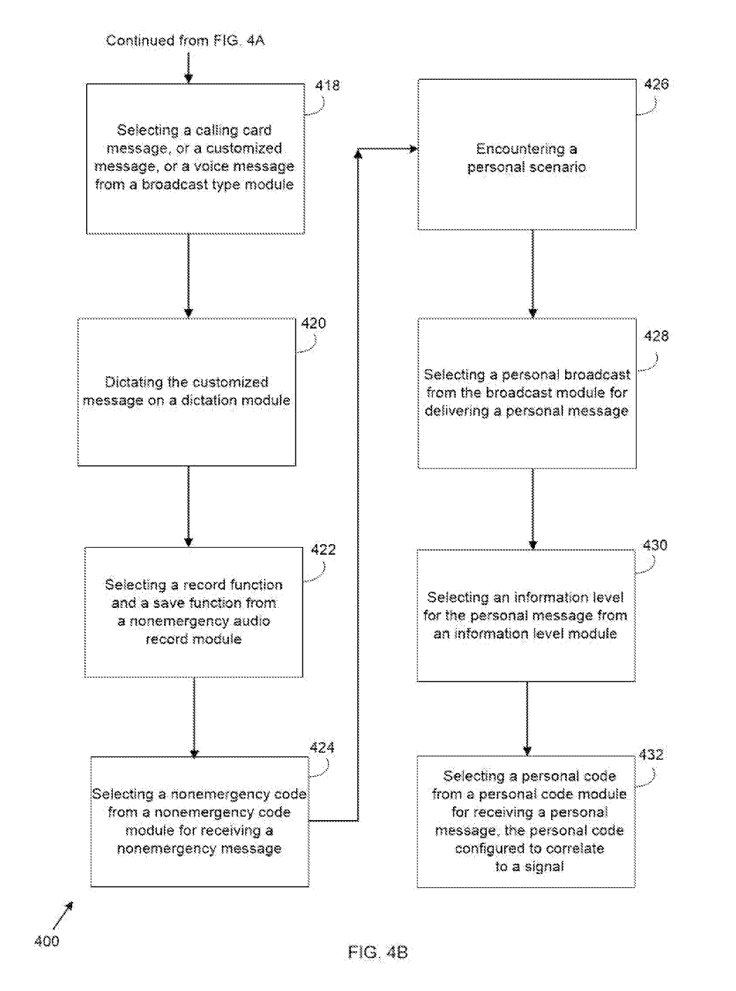

d. FIGS. 4A and 4B are a flowchart of an exemplary method for delivering content between communication devices with a short-range wireless broadcast system; and

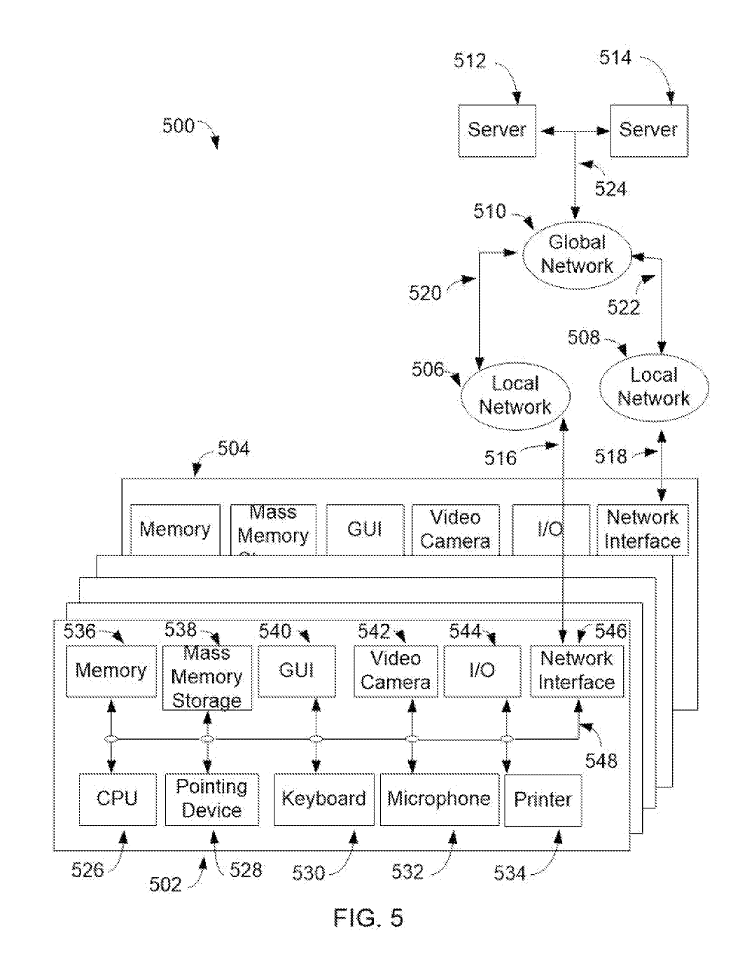

e. FIG. 5 is a block diagram depicting an exemplary client/server system which may be used by an exemplary web-enabled/networked embodiment of the present invention.

### DESCRIPTION

One embodiment of a Bluetooth broadcasting system 100 and method 400 is illustrated in FIGS. 1A-5. The Bluetooth broadcasting system 100 utilizes a short range wireless connectivity protocol, such as Bluetooth technology, to deliver content between a master communication device 140 and at least one slave communication device 142. The communication devices 140, 142 may include, without limitation, a cellular phone, a smart phone, a laptop, a tablet, a computer, and a radio.

In some embodiments, a master communication device 140 and at least one slave communication devices 142 form a common network comprising of a sender 144, a recipient 146, and public safety personnel 148 that share a system software application, often downloaded from a server or website. Those skilled in the art will recognize that Bluetooth is a wireless technology that exchanges data over short distances using short-wavelength UHF radio waves in the ISM band from about 2.4 to 2.485 GHz. The data can be exchanged from fixed and mobile devices, and building personal area networks. Bluetooth provides numerous advantages for short range communication of an emergency, or personal nature due to the capacity to hop over interferences, and utilize codes for selective distribution of content.

In some embodiments, the system 100 is configured to deliver a variety of different broadcasts. The system 100 may deliver, without limitation, an emergency broadcast 104, a nonemergency broadcast 106, and a personal broadcast 108. The system 100 can switch between broadcasts 104, 106, 108, or deliver each broadcast 104, 106, 108 simultaneously. In this manner, the system 100 utilizes the robust characteristics of Bluetooth technology to enable effective distribution of content in any scenario. Each broadcast 104, 106, 108 includes a message that may include text, images, video, audio, web links, and web pods. The content of the message may include, without limitation, emergency warnings, personal information, advertisements, instructive information, and an exchange of personal and contact information. The content is deliverable either publicly, anonymously, and/or selectively with permission based codes.

Additionally, the type of content to be delivered dictates the conditions and parameters. For example, an emergency broadcast 104 is publicly delivered from a sender to all communication devices 140, 142 in the network that are Bluetooth enabled and have downloaded the system software application. In another example, a personal message is delivered from a sender 144 to a recipient 146 on condition of the recipient possessing a unique code. The system 100 provides such diverse delivery options to operate the three types of different broadcasts.

In one example of the system 100, a tornado alert broadcasts from public safety personnel 148 to a plurality of recipients 146 in specific area codes. The broadcast is only receivable by recipients 146 who have the system software application on a Bluetooth enabled communication devices 140, 142. In another example, the system 100 is configured to openly broadcast content within an area limited by the Bluetooth's range. For instance, a professor can deliver a lecture to students that attend a specific class, and only the students on campus can receive the lecture.

Those skilled in the art will recognize that the Bluetooth technology used by the system 100 is especially effective for emergency broadcasts 104, since the Bluetooth protocol is designed to operate in noisy radio frequency environments. This is possible because Bluetooth uses a fast acknowledgement and frequency-hopping scheme to make the link robust, communication-wise. The scheme involves a radio technology called frequency-hopping spread spectrum. In this manner, Bluetooth avoids interference from other signals by hopping to a new frequency after transmitting or receiving a data packet. Furthermore, the number of hops, or portion of the data's journey during the communication, can be controlled by the system 100 to increase or decrease the range of communication. The capacity to select a range for the communication by controlling the number of hops is useful for either emergency or private broadcasts. In this manner, the advantages provided by Bluetooth technology can customize broadcasts for different situations. Thus, one of the chief advantages offered by the system 100 is that, compared with other system 100s operating in the same frequency band, the Bluetooth protocol typically hops faster and uses shorter packets. This is because short packages and fast hopping limit the impact of microwave ovens and other sources of disturbances.

Additionally, it is known in the art that the Bluetooth protocol provides a point-to-point connection with only two Bluetooth units involved, or a point-to-multipoint connection. In the point-to-multipoint connection, the channel is shared among several Bluetooth units. Two or more units sharing the same channel form a piconet. One Bluetooth unit acts as the master of the piconet, whereas the other unit(s) acts as slave(s). In one embodiment, a master communication device 140 communicates with a maximum of seven slave communication devices 142 in a piconet. Though, the communication devices 140, 142 can switch roles, by agreement, and the slave communication device 142 can become the master communication device 140. The master communication device 140 and the slave communication device 142 may share a unique code to send and receive a message for certain types of communications. However, in some embodiments, a unique code is not needed to receive the message, such as in an emergency scenario.

As referenced in FIG. 1A, the system 100 comprises three types of broadcasts 104, 106, 108, which may be visible on a display screen of both the master and slave communication device 140, 142. The broadcasts 104, 106, 108 are selective from a Broadcast Module 102 having the following broadcasts: 1) an Emergency Broadcast 104; 2) a Nonemergency Broadcast 106; and 3) a Personal Broadcast 108. The master and slave communication devices 140, 142 select the appropriate broadcast 104, 106, 108 and subsequent options that arise from the broadcast 104, 106, 108, such as a range for the message, a code for regulating reception of the message, and different amounts of personal and contact information levels.

In one embodiment, the Broadcast Module 102 relays the Emergency Broadcast 104. The Emergency Broadcast 104 may be used for a mass release of contact information, such as in a weather disaster, a criminal incident, and a large public gathering. The Emergency broadcast 104 is also useful for a victim to deliver an emergency alert to all communication devices 140, 142 in a predetermined range, such as fires, medical emergencies, rapes, shooters, and the like. The Nonemergency Broadcast 106 uses a selective contact release-and-request, such as in social gatherings, public gatherings, clubs, parks, parties, airport gate announcements, and the like. In another embodiment, the Personal Broadcast 108 is used for selective individual custom information release, such as restaurant or business waiting lines.

FIG. 1B illustrates the Emergency Broadcast 104 utilized in an emergency scenario that requires the general public and public safety personnel 148 to be alerted with an emergency message. In some embodiments, the slave communication device 142 transmits the Emergency Broadcast 104 from a victim of a crime, a natural disaster, or a health crisis. The slave communication device 142 can select from an Emergency Type Module 110 to indicate to others in the network, including public safety personnel 148, the nature of the emergency and to alert and request help. Selecting from the Emergency Type Module 110 on the slave communication device 142 displays various types of emergencies to the master communication device 140 and the other slave communication devices 142. The types of emergencies may include, without limitation Medical, Fire, Assault, Rape, and Shooter. However, the Emergency Type Module 110 can be configured to alert to myriad combinations of emergencies. For example, without limitation, a robbery victim can send an Emergency Broadcast 104 to all communication devices 140, 142 in a predetermined range, and a nearby recipient can then help or call public safety personnel 148.

In some embodiments, the master communication device 140 has the option of selecting the range of reception of the emergency message through a Range Module 112. The ranges may include, without limitation, 100 feet, 500 feet, 1,000 feet, and 5,000 feet. Generally, only public safety personnel 148 have access to the Range Module 112. For example, a public safety personnel 148 need not respond to the Emergency Broadcast 104 beyond a mile. The Range Module 112 allows for expanded message dispersion by retransmitting by the slave communication device 142 (message recipient 146) over a limited number of hops. Those skilled in the art will recognize that the slave communication device 142 controls the number of hops through a timer that incrementally reduces by a unit of 1 until zero is reached.

In some embodiments, an Emergency Audio Record Module 114 provides the option to record and/or save and send a prerecorded message. The capacity to record can be useful for public safety personnel 148. The Emergency Audio Record Module 114 allows the public safety personnel 148 to prerecord, save, and send a broadcast, such as weather alert, escaped fugitive warnings, and the like. For example, without limitation, broadcasting “white male, blue shirt, last seen on Main Street” alerts to a fugitive. The Emergency Broadcast 104 does not require a unique code to receive the broadcast, but rather, only Bluetooth connectivity and the system 100 software application are needed. The Emergency Broadcast 104 transmits to all communication devices 140, 142 in the network that have the system software application.

Turning now to FIGS. 2A and 2B, the Nonemergency Broadcast 106 can be used for broadcasting a nonemergency message that is generally public in nature. Either the master or slave communication device 140, 142 that delivers or receives the Nonemergency Broadcast 106 may broadcast the nonemergency message. The nonemergency message may include, without limitation, an advertising campaign, a company meeting, a queue at an airport, and a reservation desk. However, any form of general, nonemergency communications may be initiated through the Nonemergency Broadcast 106. The Nonemergency Broadcast 106 utilizes a nonemergency code 130 to enable reception of the nonemergency message to authorized recipients 146. Additionally, the amount of information delivered in the nonemergency message can be customized.

FIG. 2A references the Nonemergency Broadcast 106 operating with a Broadcast Type Module 116. The Broadcast Type Module 116 is configured to give the master communication device 140 the option of broadcasting a Calling Card Broadcast 118, a Customized Broadcast 120, and a Voice Broadcast 122. The Calling Card Broadcast 118 includes general contact information from a sender 144, such as a general calling or business card may have. The Calling Card Broadcast 118 may include, name, company name, address, phone number, fax, and email contact information. This contact information may be prewritten, or simply broadcast as a data packet. In some embodiments, the Calling Card Broadcast 118, the Customized Broadcast 120, and the Voice Broadcast 122 embed into the recipient's 146 communication device 140, 142 to allow for future tracking.

In some embodiments, the Customized Broadcast 120 provides a customized nonemergency message. The Customized Broadcast 120 is configured to initiate a Dictation Module 124 that enables the sender 144 to dictate the nonemergency message to the intended recipient 146. The Dictation Module 124 may include a keyboard, or a voice recognition software. In some embodiments, the Voice Broadcast 122 enables the sender 144 to record, save, and send the nonemergency message through a Nonemergency Audio Record Module 126. In any of the aforementioned broadcasts, the slave communication device 142 (recipient 146) must select the correct nonemergency code 130 to receive the nonemergency message. The nonemergency code 130 appear on a Nonemergency Code Module 128 visible to all slave communication devices 142 in the network. However, only the recipient 146 that has the nonemergency code 130 can receive the nonemergency message.

FIG. 3A shows the Personal Broadcast 108 delivering a personal message, such as personal one-on-one communications, which are often intended to be private. Examples of personal messages can include, without limitation, people meeting at a party wishing to exchange contact information, messages of a private and sensitive nature, and financial information from a financial institute. From the master communication device 140, selecting the Personal Broadcast 108 delivers a code enabled personal message to the at least one slave communication device 142. The personal message can be tailored to contain various amounts of detail through an Information Level Module 132. The Information Level Module 132 enables customization of the amount of personal and contact information relayed to the intended recipient 146. For example, a picture, name, and phone; or a picture, name, phone, and email; or a prewritten business card. However in other embodiments, any number of personal or contact information can be made available. The recipient 146 can respond to the sender 144 with a similar information level, or more or less information.

As shown in FIG. 3B, the Personal Broadcast 108 requires the intended recipient 146 to have a personal code 147 prior to receiving the personal message. The sender 144 can inform the recipient 146 of the personal code 147 verbally if using verbal signals 136. The signals 136 may include, without limitations, a number or a series of numbers. In an alternative embodiment, the sender 144 can inform the recipient 146 of the personal code 147 by using a visual signal 138 through various hand and body gestures. The visual signals 138 may include, without limitation, a thumbs up, a thumbs down, a pointed finger, an act of touching a nose, an act of touching an ear, or an act of rubbing an elbow. In this manner, the intended recipient 146, within visible proximity of the sender 144, is relayed the personal code 147 needed to receive the personal message.

In some embodiments, the verbal signal 136 or the visual signal 138 may appear on a Personal Code Module 134 on the slave communication device 142. In one example, the sender 144 performs the verbal signal 136 or the visual signal 138 from a distance so that the intended recipient 146 knows which personal code to use. The personal code 147 may include, without limitation, a symbol or a series of symbols. In one example, the sender 144 informs verbally the verbal signal 136 to the recipient 146 so that the intended recipient 146 knows which personal code to use. The personal code 147 may include, without limitations, a number or a series of numbers. The Personal Code Module 134 also provides the option of rejecting the Personal Broadcast 108.

In another embodiment, the master communication device 140 is configured to view a plurality of potential recipients 146 for potentially receiving the personal message. The master communication device 140 can then select the desired recipient 146 to send the personal message to. The sender 144 may then relay the personal code 136 to the recipient 146 through the described techniques so that the recipient 146 can enter the personal code 136 into the Personal Code Module 134. In some embodiments, the recipient 146 can reject the personal message by ignoring requests within a predetermined duration. There may be a time limitation on entering the personal code 136 into the Personal Code Module 134 as an additional security feature. For example, after ten seconds of not entering the personal code 136, the personal message is cancelled. However, once accepted, the contact information of the sender 144 and/or recipient 146 can be stored into a contacts file in the respective communication devices 140, 142.

FIGS. 4A and 4B are a flowchart of an exemplary method 400 for delivering content between communication devices 140, 142 with a short-range wireless broadcast system. The method 400 includes an Emergency Broadcast 104, a Nonemergency Broadcast 106, and a Personal Broadcast 108. The master and slave communication devices 140, 142 select the appropriate broadcast 104, 106, 108 and subsequent options, such as a range for the message, a nonemergency code 130 or personal code 136 for regulating reception of the message, and different amounts of personal and contact information levels. The method 400 includes an initial Step 402 of enabling a short-range wireless broadcast system for delivering a broadcast between a master communication device 140 and at least one slave communication device 142. The Bluetooth broadcasting system 100 utilizes a Bluetooth protocol to deliver content between a master communication device 140 and at least one slave communication device 142.

A next Step 404 may include encountering an emergency scenario. The emergency scenario may include various types of emergencies including, without limitation Medical, Fire, Assault, Rape, and Shooter. However, the emergency scenario may also include myriad combinations of emergencies. In some embodiments, a Step 406 involves selecting an Emergency Broadcast 104 from a Broadcast Module 102. The Emergency Broadcast 104 is effective for delivering an emergency message. The Emergency Broadcast 104 is used for a mass release of contact information, such as in lectures or in a meeting environment. The Emergency Broadcast 104 is also useful for mass releases of emergency alerts, such as fires, medical emergencies, rapes, shooters, and the like.

A Step 408 may include selecting a type of emergency from an Emergency Type Module 110. Selecting from the Emergency Type Module 110 on the slave communication device 142 displays various types of emergencies to the master communication device 140 and the at least one slave communication device 142. The types of emergencies may include, without limitation, Medical, Fire, Assault, Rape, and Shooter. However, the Emergency Type Module 110 can be configured to alert to myriad combinations of emergencies. A Step 410 comprises selecting a broadcast range from a Range Module 112. The master communication device 140 has the option of selecting the range of reception of the emergency message through the Range Module 112. The ranges may include, without limitation, 100 feet, 500 feet, 1,000 feet, and 5,000 feet. Generally, only public safety personnel 148 have access to the Range Module 112. In some embodiments, a Step 412 includes selecting a record function and a save and send function from an Emergency Audio Record Module 114. The capacity to record a message can be useful for repetitively alerting to an emergency scenario, such as “Stay indoors. Tornado warning in surrounding counties until 8 p.m.”

The method 400 further includes a Step 414 of encountering a nonemergency scenario. Either the master or slave communication device 142 that delivers or receives the Nonemergency Broadcast 106 may broadcast the nonemergency message, such as an advertising campaign, a company meeting, a queue at an airport, and a reservation desk. However, any form of general, nonemergency communications may be initiated through the Nonemergency broadcast 106.A Step 416 comprises selecting a Nonemergency Broadcast 106 from the Broadcast Module 102 for delivering a nonemergency message. A Step 418 comprises selecting a Calling Card Broadcast 118, a Customized Broadcast 120, or a Voice Broadcast 122 from a Broadcast Type Module 116. The Broadcast Type Module 116 is configured to give the master communication device 140 the option of broadcasting a Calling Card Broadcast 118, a Customized Broadcast 120, and a Voice Broadcast 122.

In some embodiments, a Step 420 comprises dictating the Customized Broadcast 120 on a Dictation Module 124. The Calling Card Broadcast 118 includes general contact information from a sender 144, such as a general calling or business card may have. The Customized Broadcast 120 enables the sender 144 to tailor a specific nonemergency message, rather than redeliver prior nonemergency messages. The Voice Broadcast 122 can use a human voice, audible tones, or music to relay the nonemergency message. In some embodiments, a Step 422 may include selecting a record function and a save and send function from a Nonemergency Audio Record Module 126. In this manner, the nonemergency message can be played repetitively without needing a live sender.

A Step 424 comprises selecting a nonemergency code 130 from a Nonemergency Code Module 128 for receiving a nonemergency message. The Nonemergency Broadcast 106 utilizes a nonemergency code 130 to enable reception of the nonemergency message to an authorized recipient 146. The recipient 146 must know the nonemergency code 130 and enter into the slave communication device 142 to receive the nonemergency message. The nonemergency code 130 may include a multiple digit number.

The method 400 further includes a Step 426 of encountering a personal scenario. Personal Broadcast 108 delivering a personal message, such as personal one-on-one communications, which are often intended to be private. Examples of personal messages can include, without limitation, people meeting at a party wishing to exchange contact information, messages of a private and sensitive nature, and financial information from a financial institute. A Step 428 may include selecting a Personal Broadcast 108 from the Broadcast Module 102 for delivering a personal message. In some embodiments, a Step 430 comprises selecting an information level for the personal message from an Information Level Module 132. The personal message can be tailored to contain various amounts of detail through an Information Level Module 132. The Information Level Module 132 enables customization of the amount of personal and contact information relayed to the intended recipient 146.

A final Step 432 includes selecting a personal code by selecting the verbal signal 136 and/or the visual signal 138 from a Personal Code Module 134 for receiving a personal message. The Personal Broadcast 108 requires the intended recipient 146 to have a personal code 147 prior to receiving the personal message. In one embodiment, the sender 144 can inform the recipient 146 of the personal code 147 verbally if using the verbal signals 136. The verbal signal 136 may include, without limitations, a number or a series of numbers and also provides the option of rejecting the Personal Broadcast 108. In another embodiment, the sender 144 can inform the recipient 146 of the personal code 147 visually by performing a visual signal 138 through various hand and body gestures. The visual signal 138 may include, without limitation, a thumbs up, a thumbs down, a pointed finger, an act of touching a nose, an act of touching an ear, or an act of rubbing an elbow. [0062] FIG. 5 is a block diagram depicting an exemplary client/server system which may be used by an exemplary web-enabled/networked embodiment of the present invention.

A communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones.

Client 502 includes a CPU 526, a pointing device 528, a keyboard 530, a microphone 532, a printer 534, a memory 536, a mass memory storage 538, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the Bluetooth broadcasting system 100 and method 400 could be utilized for immediate polling at a political debate. The system 100 and method 400 could be tied in with a social media site to provide real time responses from attendees at the political debate. Accordingly, the scope should be determined not by the embodiments illustrated, but by the appended claims and their legal equivalents.

What is claimed is:

1. A short-range wireless broadcast system for delivering content between communication devices publicly and/or selectively, the system comprises:
a broadcast module that categorizes a broadcast for delivery, wherein the broadcast for delivery is an emergency broadcast, a nonemergency broadcast, or a personal broadcast, the broadcast module broadcasts a message between a master communication device and at least one slave communication device;
a range module that sets a range for the broadcast; and
an audio record module records, saves, and sends the message.

2. The system of claim 1, wherein the short-range wireless broadcast is a Bluetooth protocol.

3. The system of claim 2, wherein the master communication device and each one slave communication device are smart phones.

4. The system of claim 3, wherein the message is the emergency broadcast and the system further comprises an emergency module that categorizes an emergency scenario.

5. The system of claim 4, wherein the emergency scenario is a medical emergency, a fire emergency, a rape emergency, an assault emergency, or a shooter emergency.

6. The system of claim 5, wherein the broadcast module allows each slave communication device to broadcast the emergency broadcast to the master communication device and/or other slave communication devices.

7. The system of claim 3, wherein the message is the nonemergency broadcast between the master communication device and each slave communication device.

8. The system of claim 3, wherein the broadcast module regulates the amount and type of information in the nonemergency message.

9. The system of claim 8, further comprising a dictation module that is used by a user of the master communication device or each slave communication device to dictate the nonemergency message.

10. The system of claim 9, further comprising an emergency code module that enables selection of an emergency code.

11. The system of claim 10, wherein the nonemergency broadcast is received by each slave communication device having the nonemergency code.

12. The system of claim 3, wherein the message is the personal broadcast between the master communication device and each slave communication device.

13. The system of claim 12, further comprising an information level module that regulates an amount of personal information in the personal broadcast.

14. The system of claim 13, further comprising a personal code module configured to enable selection of a personal code.

15. The system of claim 14, wherein the personal broadcast is received by each slave communication device having the nonemergency code.

16. The system of claim 15, wherein personal broadcast is a calling card broadcast, a custom broadcast, or a voice broadcast.

17. The system of claim 16, wherein the calling card broadcast has contact information of either the master communication device or each slave communication device.

18. The system of claim 17, further comprising a dictation module that is used by a user of the master communication device or each slave communication device to dictate a customized nonemergency message.

19. The system of claim 18, wherein the information level module is a picture/name/phone information packet, a picture/name/phone/email information packet, a picture/name/internet social site information packet, or a business card information packet.

20. The system of claim 19, wherein the code selection module provides a letter, the letter corresponds to a signal that is sent by the master communication device or each slave communication device to initiate or reject the personal broadcast between devices.
